(19) United States
(12) Patent Application Publication
(10) Pub. No.: US 2008/0300056 A1
(43) Pub. Date: Dec. 4, 2008

(54) Telephone Enabled Elimination Game

(75) Inventor: Victor Tyrone Lam, Carlsbad, CA (US)

Correspondence Address: FISH & RICHARDSON, PC, P.O. BOX 1022, MINNEAPOLIS, MN, 55440-1022, US

(73) Assignee: NTN BUZZTIME, INC., Carlsbad, CA (US)

(21) Appl. No.: 11/755,682

(22) Filed: May 30, 2007

(51) Int. Cl. G06F 17/00

(52) U.S. Cl. 463/40

(57) ABSTRACT

An interactive tournament which involves sending questions to interactive devices such as cell phones or PDAs. The question that is received must be answered in a specified period of time e.g. 10 minutes. Proper answers go on to the next round, improper or late answers cause the player to be eliminated. The game continues till either only a plurality of players are left or only one player is left. As time goes on the game becomes progressively more difficult. The difficulty may be more difficult questions and/or may be more difficult times.

### BACKGROUND

Many different games are playable over networks. Such games may be playable over public or private networks. NTN, the Buzztime assignee of the present application, produces different kinds of games including trivia games that are playable over such a network.

### SUMMARY

The present application describes a multiplayer game that can be played over a personal communicating device such as a cell phone.

### BRIEF DESCRIPTION OF THE DRAWINGS

These and other aspects will now be described in detail with reference to the accompanying drawings, wherein:

FIG. 1 shows an embodiment; and

FIG. 2 shows a flowchart which may be executed as a routine that runs on the server.

### DETAILED DESCRIPTION

The general structure and techniques, and more specific embodiments which can be used to effect different ways of carrying out the more general goals, are described herein.

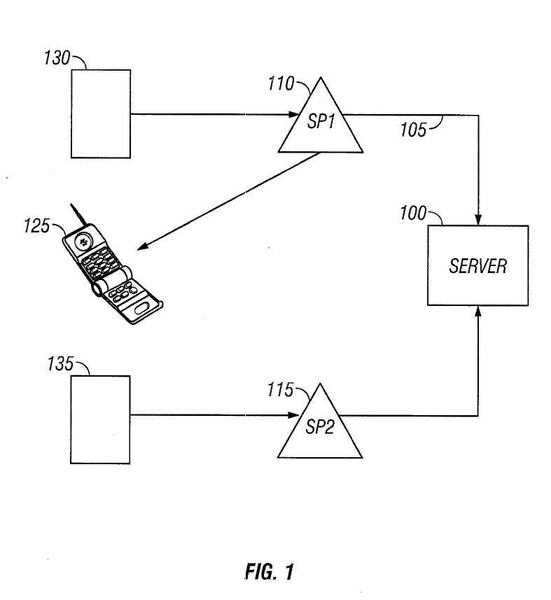

An embodiment is shown in FIG. 1. A server 100 is the main playing server that runs a routine that allows interactive play on a plurality of subscriber devices. An embodiment describes playing a trivia based game in this way. However, other embodiments describe using math questions, puzzles, knowledge questions, teaching aids, and/or others to be played in this way.

The server 100 connects via one or more channels 105 to respective service providers 110, 115. Alternatively, the server may connect to more service providers or to a fewer number of service providers. Each service provider may itself can be connected to subscriber devices. The service provider 110 is shown connected to a subscriber device 125, here shown as a cell phone, and also to a second subscriber device 130 which may be a cell phone, PDA, or any other device. The service provider 115 is also shown connected to a subscriber.

In operation, the server 100 operates to host a game that is a single elimination tournament. All of the subscribers who subscribe to the tournament will receive the same question on their mobile phone at approximately the same time, and have a predetermined time to send the correct answer back to the server 100. The basic idea is that each of the players to correctly answer the question within the allowed time frame are allowed remain in the tournament. These players will receive another question at some future point in time. The game continues until only one player remains. One by one, the players are eliminated in this way. The last player remaining, also called last player standing, is the winner.

An embodiment requires that only one player be left. According to another embodiment, it may be possible to allow multiple different players to simultaneously win, for example if a certain number of players are not removed at each round, the remaining players may be declared joint winners (assuming that there are less than a certain number of those players).

A game of this type may be a cash play if laws so allow. This embodiment operates to ensure that the winner is selected solely based on skill as compared with other players in the same competition. In an embodiment, all players receive the same questions at substantially the same time and continue to compete until all but one player incorrectly answers a question. According to an alternative embodiment, a game can be carried out as a sweepstakes game, in essence without any skill being necessary.

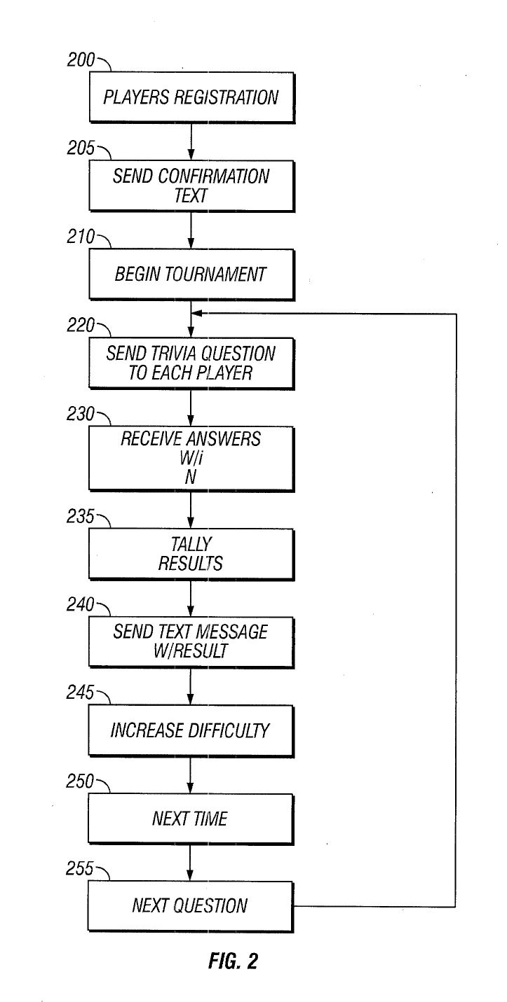

The embodiment may follow the flowchart of FIG. 2, which may be executed as a routine that runs on the server 100.

At 200, prior to the start of the game, the players register to be included in the tournament. This registration can be via a website, for example. As part of the registration process, each player may enter their player information, such as a pre-assigned or desired player name, their real name and contact information, and/or cell phone number. In an embodiment, there is also an entrance fee, which can be paid using a credit card or PayPal account.

At 205, the main server sends a confirmation text, e.g. via SMS, to the mobile phone. This allows the mobile phone user to opt into the tournament via the wireless carrier's terms of service. The opt-in may be via a return text that is sent, or may alternatively be in some other way. The tournament is then started at 210. The tournament may be started when there are a predetermined number of players, or may be started based on timing; for example at five minutes after each hour. The tournament may also choose to limit the number of players in the tournament to make the odds more uniform.

After beginning the tournament, at 220, the server sends each player the same trivia question with multiple choice answers. This trivia question is sent to every player who has opted in to the tournament. Each player will have a predetermined amount of time to respond. Different times may be allowed for different latency from different carriers. The objective of the selected time is to allow enough time for carrier latency, but not to allow so much time to allow the respondents to research the answer.

An embodiment may allow 10 minutes, for example, as the deadline for the server to receive its answers. More generally, however, any answers received within a time are counted, and once the deadline is closed, no further answers can be counted. The time is preferably less than one hour, more preferably 10 minutes or less.

At 235, the central server tallies the results, and separates between those who answer correctly and those who do not answer correctly. Those who do not answer correctly are eliminated from the competition. Players are sent a text message at 240 with the results. This text message may indicate whether the player has answered correctly; and may also indicate other information about the tournament, for example the percentage and/or the number of players that answered correctly and incorrectly.

In an embodiment, easier questions are sent earlier in the tournament, and the questions may become more difficult as time goes on. 245 shows the operation of increasing the difficulty of the question, so that the next question is at least slightly more difficult than the previous question.

The next question will be sent at some future time, for example within 24 hours. The time when the information is sent may be random, for example. At the assign time, the next question is selected at 255. The flow then returns to 220 which sends the trivia question and begins receiving answers.

The game has a number of objectives. One objective is to determine the winner by their trivia knowledge, but another is to have a phone close and ready to allow a response prior to the deadline. The trivia knowledge may be assured by selecting the time for a response and a time that is fast enough to prevent a user from researching the answer. In addition, as the tournament progresses, all of the factors may become more difficult, including the difficulty of the trivia, as well as the time when the previous question is sent. For example, in one embodiment, the trivia question might be sent at 4 a.m. in order to make it even more difficult to answer. There may be an additional advantage of sending messages in the middle of the night, since the costs to send such messages may be lower. A variable cost of sending messages to unknown numbers of recipients may be managed by sending them in this way.

The embodiment as described in this game being a trivia type game. However, it should be noted that as described previously the game may be totally based on luck such as a sweepstakes, or may be based on other factors. The game can be played on mobile phones, on PDAs or other online connected devices, on PCs, game consoles, interactive television set-top boxes, or as a single tournament exclusive to only one platform such as a mobile phone. The game may alternatively be played as a cross-platform tournament across two or more platforms.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of games can be played on other platforms.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method, comprising:
maintaining a list of communication devices which are participating in an interactive session;
sending at least one interactive request to a plurality of communication devices from said list;
receiving answers to said interactive requests from said plurality of communication device;
determining which of said answers meet a specified criteria and are also received within a specified time after said sending;
removing communication devices from said list which did not provide said answers meeting said specified criteria with said specified time; and
subsequently sending at least one more question to said communication devices on said list.

2. A method as in claim 1, wherein said subsequently sending comprises continuing said sending, receiving and determining until a specified number of communication devices remain on said list.

3. A method as in claim 2, wherein said communication devices include cell phones.

4. A method as in claim 2, wherein said communication devices include PDAs.

5. A method as in claim 1, wherein said subsequently sending comprises continuing said sending, receiving and determining until only one communication device remains on said list.

6. A method as in claim 2, wherein said interactive request is a question and said answer comprises a proper answer to said question.

7. A method as in claim 6, wherein said question is a trivia question.

8. A method as in claim 2, further comprising an initial step of registering for the interactive session, wherein said registering comprises paying a fee for the entry, and responsive to said paying said fee and registering, adding information based on said registering, to said list.

9. A method as in claim 3, wherein said questions and said answers are sent via SMS.

10. A method as in claim 8, further comprising terminating said registering once a specified number of players have already registered.

11. A method as in claim 2, further comprising sending message responses to each of the devices on said list after each question time has elapsed, said message responses indicating whether the device has properly answered the question.

12. A method as in claim 2, further comprising making subsequent questions more difficult.

13. A method as in claim 2, further comprising making subsequent questions occur at a more difficult time to answer.

14. A method, comprising:
allowing a plurality of players to register for an interactive game;
responsive to each registration, adding information indicative of a new player to a list of players;
sending each of the players on said list an interactive question which must be answered in a specified time;
sending only those of the players who answered the interactive question properly within the specified time another question which is more difficult than the first question, and must be answered within a specified time; and
continuing said second sending until only a specified number of said players remain.

15. A method as in claim 14, wherein said specified number of players is one player.

16. A method as in claim 14, wherein said sending comprises sending information to a cell phone.

17. A method as in claim 16, wherein said sending is via SMS.

18. A method as in claim 16, wherein said sending further comprises sending other information to a PDA which has communication capabilities.

19. A method as in claim 16, wherein said sending comprises sending a trivia question.

20. A method as in claim 14, wherein said second sending comprises sending a question at a time which is more difficult to answer.

21. A computer system, comprising:
a first part, which connects to a wireless network that allows sending communications to a plurality of different wireless subscribers; and
a second part, that includes a program that runs to establish an interactive game, said program operating to maintain a list of communication devices which are participating in an interactive session, sending at least one interactive request to communication devices from said list and monitor for answers from said communication devices on said list, to determining which of said answers meet a specified criteria and are also received within a specified time after said sending, to remove communication devices whose answers are not received within a specified time from said list and subsequently sending at least one more question to said communication devices that are still on said list.

22. A system as in claim 21, wherein said subsequently sending comprises continuing to send questions until a specified number of communication devices remain on said list.

23. A system as in claim 22, wherein said connection to said wireless network comprises a connection to a cell phone via SMS.

24. A system as in claim 22, wherein said connection to said wireless network comprises a connection to a PDA.

25. A system as in claim 22, wherein said interactive request is a question and said answer comprises a proper answer to said question.

26. A system as in claim 25, wherein said question is a trivia question.

27. A system as in claim 22, wherein said second part also allows registering for the interactive session, wherein said registering comprises paying a fee for the entry, and responsive to said paying said fee and registering, adds information indicative of a registrant to said list.

28. A system as in claim 27, further comprising terminating said registering once a specified number of players have already registered.

29. A system as in claim 22, wherein said second part makes subsequent questions more difficult.

30. A system as in claim 22, wherein said second part makes subsequent questions occur at a more difficult time to answer.
